(19) United States
(12) Patent Application Publication
(10) Pub. No.: US 2012/0027589 A1
(43) Pub. Date: Feb. 2, 2012

(54) METHOD AND APPARATUS FOR CONTROL OF ASYMMETRIC LOADING OF A WIND TURBINE

(76) Inventors: Christian Haag, Karlstad (SE); Ulf Axelsson, Karlstad (SE); Mikael Bjõrk, Karlstad (SE); Christoph Schulten, Salzbergen (DE); Gert Torbohm, Rheine (DE)

(21) Appl. No.: 13/116,443

(22) Filed: May 26, 2011

(51) Int. Cl. F03D 7/04

(52) U.S. Cl. 416/1; 416/13

(57) ABSTRACT

A wind turbine (10) is provided. The wind turbine includes a rotor (18), at least one rotor blade (22) coupled to the rotor, and a yaw system (92). The yaw system (92) includes at least one yaw motor (94) for adjusting a yaw angle of the wind turbine (10). The yaw system (92) is configured for generating a yaw drive signal corresponding to at least one of: i) a property from the at least one yaw motor (94); or ii) a control signal for operating the at least one yaw motor. The wind turbine (10) further includes an asymmetric load control assembly (100) configured to receive the yaw drive signal. The asymmetric load control assembly (100) is further configured to mitigate an asymmetric load acting on the rotor (18) using the yaw drive signal. A control system for operating a wind turbine (10) and a method thereof are also provided.

### BACKGROUND OF THE INVENTION

The subject matter described herein relates generally to methods and systems for controlling a wind turbine, and more particularly, to methods and systems for mitigating asymmetric loading of a wind turbine.

Generally, wind turbines include a tower and a nacelle mounted on the tower. A rotor is rotatably mounted to the nacelle and is coupled to a generator by a main shaft. A plurality of blades extends from the rotor. The blades are oriented such that wind passing over the blades turns the rotor and rotates the shaft, thereby driving the generator to generate electricity.

Vertical and horizontal wind shears, yaw misalignment and/or wind turbulence may act either collectively or individually for producing an asymmetric loading of the wind turbine. In particular, such an asymmetric loading may act across the wind turbine rotor. As a result, at least some elements of the wind turbine may be deformed. For example, the main shaft of the wind turbine may be bent (e.g., radially displaced) as a result of asymmetric rotor loading.

In order to mitigate the effect of the asymmetric loading of a wind turbine, a set of sensors for asymmetric load control (ALC) such as, for example, an array of proximity sensors, may be provided in the wind turbine to directly measure deformation of at least some elements of the wind turbine, such as a bending of the main shaft. An ALC assembly may use signals generated by the ALC sensors for mitigating the effect of asymmetric load of the rotor by, for example, controlling blade pitch and/or yaw alignment of the wind turbine. ALC may facilitate reducing the effects of extreme loads and fatigue cycles acting on the wind turbine.

However, additional methods and systems for further reducing asymmetric loading and/or increasing reliability of ALC are desirable.

### BRIEF DESCRIPTION OF THE INVENTION

According to an embodiment of the invention, a wind turbine is provided. The wind turbine includes a rotor, at least one rotor blade coupled to the rotor, and a yaw system. The yaw system includes at least one yaw motor for adjusting a yaw angle, of the wind turbine. The yaw system is configured for generating a yaw drive signal. The wind turbine further includes an asymmetric load control assembly configured to receive the yaw drive signal. The asymmetric load control assembly is further configured to mitigate an asymmetric load acting on the rotor using the yaw drive signal.

According to another embodiment of the invention, a method of operating a wind turbine is provided. The wind turbine includes a rotor, at least one rotor blade coupled to the rotor, and a yaw system including at least one yaw motor for adjusting a yaw angle of the wind turbine. The method further includes mitigating an asymmetric load acting on the rotor using the yaw drive signal.

In yet another embodiment of the invention, a control system for a wind turbine is provided. The wind turbine includes at least one yaw motor for adjusting a yaw angle of the wind turbine. The control system includes an asymmetric load control assembly configured to receive a yaw drive signal. The asymmetric load control assembly is further configured to mitigate an asymmetric load acting on the rotor using the yaw drive signal.

According to embodiments herein, a yaw drive signal typically corresponds to, at least, a property from the at least one yaw motor. Such a property may be, for example, a torque generated by the yaw motor. Alternatively or in addition thereto, the yaw drive signal may correspond to a control signal for operating the at least one yaw motor. For example, the yaw drive signal may correspond to a set point generated for operating the at least one yaw motor.

According to embodiments herein, a yaw system may facilitate a yaw drive signal, which may be used as reference data to directly implement control of asymmetric rotor loading or increase reliability of ALC based on the use of ALC sensors. In particular, embodiments herein facilitate mitigating asymmetric rotor loading by implementing an asymmetric load control assembly configured such that it may use the yaw drive signal. According to at least some embodiments herein, the yaw drive signal is generated by a yaw system.

Further aspects, advantages and features of the present invention are apparent from the dependent claims, the description and the accompanying drawings.

### BRIEF DESCRIPTION OF THE DRAWINGS

A full and enabling disclosure including the best mode thereof, to one of ordinary skill in the art is set forth more particularly in the remainder of the specification, including reference to the accompanying figures wherein:

FIG. 1 is a perspective view of an exemplary wind turbine;

FIG. 2 is an enlarged sectional view of a portion of the wind turbine shown in FIG. 1;

FIG. 3 is a schematic drawing of a yaw system of the wind turbine shown in FIG. 1;

FIG. 4 is a block diagram of a scheme for controlling the wind turbine shown in FIG. 1;

FIG. 5 is an enlarged perspective view of another portion of the wind turbine shown in FIG. 1;

FIG. 6 is a flow chart illustrating a method of operating the wind turbine shown in FIG. 1.

### DETAILED DESCRIPTION OF THE INVENTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with other embodiments to yield yet further embodiments. It is intended that the present disclosure includes such modifications and variations.

As mentioned above, vertical and horizontal wind shears, yaw misalignment, wake flow caused by another wind turbine, and/or turbulence may act individually or together to produce asymmetric loading across a wind turbine rotor. A resultant asymmetric load produces bending moments in the blades that are reacted through the hub and subsequently to a wind turbine shaft. Such an asymmetric load may cause deformations of elements in the wind turbine, such as a bending or radial displacement of the main shaft.

The embodiments described herein facilitate reducing asymmetric loading acting on the rotor of a wind turbine system. Further, embodiments herein may increase reliability of asymmetric load control (ALC) of a wind turbine. In particular, the wind turbine includes a yaw system for adjusting a yaw angle of the wind turbine. Typically, the yaw angle is adjusted by at least one yaw motor operated by a yaw control assembly. According to at least some embodiments herein, the yaw system is a soft yaw system. In particular, the yaw system may be a soft yaw system configured to actively restrict rotation of the nacelle about a yaw angle by continuously operating the yaw motor.

An asymmetric load control assembly (hereinafter referred to as ALC assembly) according to embodiments herein is typically configured for receiving a yaw drive signal generated by a yaw system. The yaw drive signal may then be used to determine the magnitude and/or the orientation of the resultant rotor load. Thereby, the ALC assembly may use the yaw drive signal for mitigating an asymmetric load.

The yaw drive signal may correspond to one or more properties from the at least one yaw motor such as, but not limited to, a generated torque. Exemplarily, but not limited to, the yaw drive signal may correspond to an electrical current applied to the yaw motor, which current corresponds to a torque applied by the yaw motor.

Alternatively or in addition thereto, the yaw drive signal may correspond to a control signal for operating the at least one yaw motor. In particular, the yaw system may receive a reference signal for re-aligning or maintaining a yaw angle. For example, this reference signal may include information about oncoming wind such as a wind direction measured by a wind vane. Typically, the yaw system is configured to use this reference signal for generating a control signal for operating the at least one yaw motor, such as a yaw motor set point. Typically, a yaw motor set point is a motor torque, a motor speed, direction, and/or nacelle position that the yaw system strives to set through actuation of the at least one yaw motor.

According to embodiments herein, mitigating asymmetric loads may include reducing or countering asymmetric rotor loading. Thereby, an ALC assembly is typically configured for causing a more symmetric load on the rotor. The ALC assembly may mitigate the asymmetric load by adequately pitching the blades of the wind turbine.

The ALC assembly may mitigate the asymmetric loads directly based on the yaw drive signal. For example, the ALC assembly may implement a control scheme configured to produce a control signal based on the yaw drive signal for reducing the asymmetric loads. Alternatively, or in addition thereto, the wind turbine may implement an ALC sensor system for directly sensing asymmetric loads acting on the rotor. In such embodiments, the ALC assembly may mitigate the asymmetric loads directly based on the measurements of the ALC sensor system and use the yaw drive signal for validating the measurements. Thereby, embodiments herein may facilitate increasing reliability of ALC of the wind turbine.

In a wind turbine implementing an ALC sensor system, the yaw drive signal may also be used for redundancy purposes in the case that the ALC sensor system fails. Further, the yaw drive signal may also be used in combination with the measurements of the sensor system for generating an ALC signal.

As used herein, the term “blade” is intended to be representative of any device that provides a reactive force when in motion relative to a surrounding fluid. As used herein, the term “wind turbine” is intended to be representative of any device that generates rotational energy from wind energy, and more specifically, converts kinetic energy of wind into mechanical energy. As used herein, the term “wind generator” is intended to be representative of any wind turbine that generates electrical power from rotational energy generated from wind energy, and more specifically, converts mechanical energy converted from kinetic energy of wind to electrical power.

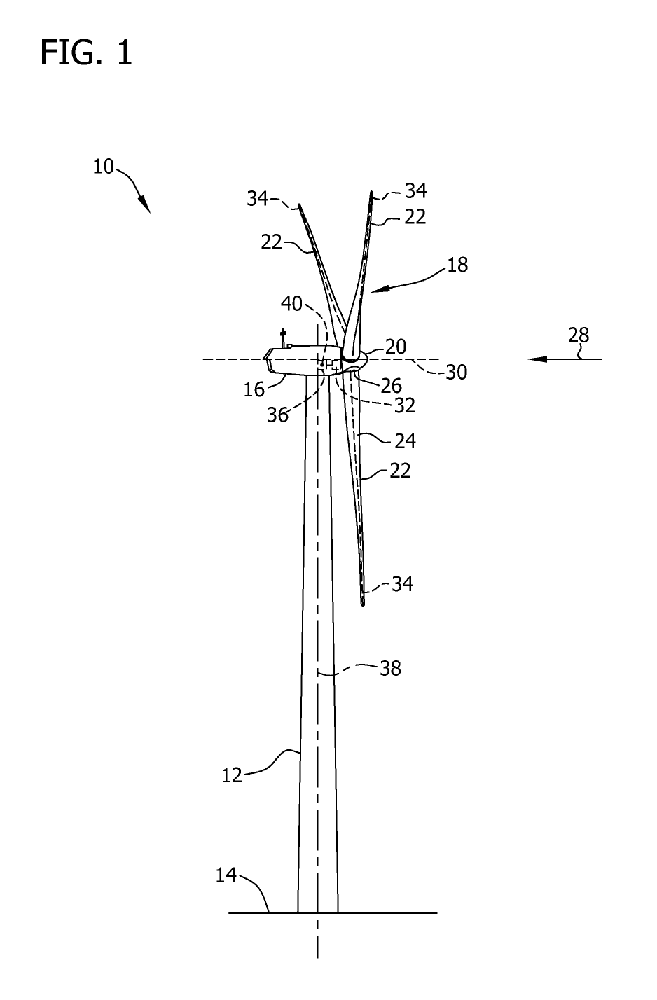

FIG. 1 is a perspective view of an exemplary wind turbine 10. In the exemplary embodiment, wind turbine 10 is a horizontal-axis wind turbine. Alternatively, wind turbine 10 may be a vertical-axis wind turbine. In the exemplary embodiment, wind turbine 10 includes a tower 12 that extends from a support system 14, a nacelle 16 mounted on tower 12, and a rotor 18 that is coupled to nacelle 16. Rotor 18 includes a rotatable hub 20 and at least one rotor blade 22 coupled to and extending outward from hub 20. In the exemplary embodiment, rotor 18 has three rotor blades 22. In an alternative embodiment, rotor 18 includes more or less than three rotor blades 22. In the exemplary embodiment, tower 12 is fabricated from tubular steel to define a cavity (not shown in FIG. 1) between support system 14 and nacelle 16. In an alternative embodiment, tower 12 is any suitable type of tower having any suitable height.

Rotor blades 22 are spaced about hub 20 to facilitate rotating rotor 18 to enable kinetic energy to be transferred from the wind into usable mechanical energy, and subsequently, electrical energy. Rotor blades 22 are mated to hub 20 by coupling a blade root portion 24 to hub 20 at a plurality of load transfer regions 26. Load transfer regions 26 have a hub load transfer region and a blade load transfer region (both not shown in FIG. 1). Loads induced to rotor blades 22 are transferred to hub 20 via load transfer regions 26.

In one embodiment, rotor blades 22 have a length ranging from about 15 meters (m) to about 91 m. Alternatively, rotor blades 22 may have any suitable length that enables wind turbine 10 to function as described herein. For example, other non-limiting examples of blade lengths include 10 m or less, 20 m, 37 m, or a length that is greater than 91 m. As wind strikes rotor blades 22 from a direction 28, rotor 18 is rotated about an axis of rotation 30. As rotor blades 22 are rotated and subjected to centrifugal forces, rotor blades 22 are also subjected to various forces and moments. As such, rotor blades 22 may deflect and/or rotate from a neutral, or non-deflected, position to a deflected position.

Moreover, a pitch angle or blade pitch of rotor blades 22, i.e., an angle that determines a perspective of rotor blades 22 with respect to direction 28 of the wind, may be changed by a pitch adjustment system 32 to control the load and power generated by wind turbine 10 by adjusting an angular position of at least one rotor blade 22 relative to wind vectors. Pitch axes 34 for rotor blades 22 are shown. During operation of wind turbine 10, pitch adjustment system 32 may change a blade pitch of rotor blades 22 such that rotor blades 22 are moved to a feathered position, such that the perspective of at least one rotor blade 22 relative to wind vectors provides a minimal surface area of rotor blade 22 to be oriented towards the wind vectors, which facilitates reducing a rotational speed of rotor 18 and/or facilitates a stall of rotor 18.

In the exemplary embodiment, a blade pitch of each rotor blade 22 is controlled individually by a control system 36. Alternatively, the blade pitch for all rotor blades 22 may be controlled simultaneously by control system 36. Further, in the exemplary embodiment, as direction 28 changes, a yaw direction of nacelle 16 may be controlled about a yaw axis 38 to position rotor blades 22 with respect to direction 28.

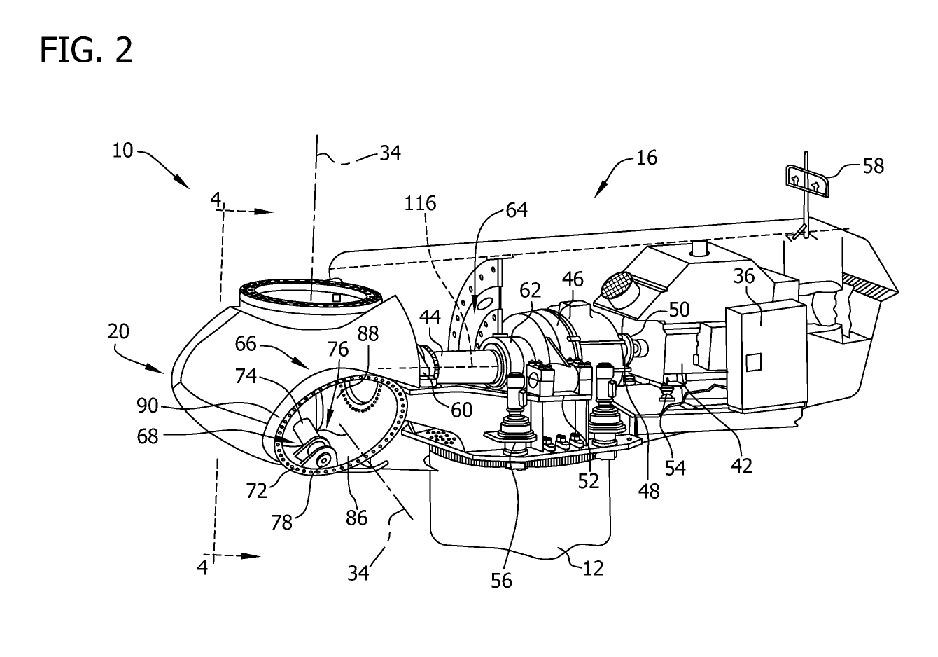

FIG. 2 is an enlarged sectional view of a portion of wind turbine 10. In the exemplary embodiment, wind turbine 10 includes nacelle 16 and hub 20 that is rotatably coupled to nacelle 16. More specifically, hub 20 is rotatably coupled to an electric generator 42 positioned within nacelle 16 by rotor shaft 44 (sometimes referred to as either a main shaft or a low speed shaft), a gearbox 46, a high speed shaft 48, and a coupling 50. In the exemplary embodiment, rotor shaft 44 is disposed coaxial to longitudinal axis 116. Rotation of rotor shaft 44 rotatably drives gearbox 46 that subsequently drives high speed shaft 48. High speed shaft 48 rotatably drives generator 42 with coupling 50 and rotation of high speed shaft 48 facilitates production of electrical power by generator 42. Gearbox 46 and generator 42 are supported by a support 52 and a support 54. In the exemplary embodiment, gearbox 46 utilizes a dual path geometry to drive high speed shaft 48. Alternatively, rotor shaft 44 is coupled directly to generator 42 with coupling 50. For example, wind turbine 10 may be based on a direct-drive design.

In the exemplary embodiment, hub 20 includes a pitch assembly 66. Pitch assembly 66 may include a pitch controller 73 (shown in Figure) operatively coupled to one or more pitch drive systems 68. Each pitch drive system 68 is coupled to a respective rotor blade 22 (shown in FIG. 1) for modulating the blade pitch of associated rotor blade 22 along pitch axis 34. Only one of three pitch drive systems 68 is shown in FIG. 2. Please note that pitch controller 73 may be a centralized controller associated to a plurality of pitch drive 68, such as exemplarily shown in FIG. 4. Alternatively, wind turbine 10 may include a distributed pitch controller including, for example, a plurality of pitch controllers, each of the pitch controllers being associated to a respective pitch drive 68.

In the exemplary embodiment, pitch assembly 66 includes at least one pitch bearing 72 coupled to hub 20 and to respective rotor blade 22 (shown in FIG. 1) for rotating respective rotor blade 22 about pitch axis 34. Pitch drive system 68 includes a pitch drive motor 74, pitch drive gearbox 76, and pitch drive pinion 78. Pitch drive motor 74 is coupled to pitch drive gearbox 76 such that pitch drive motor 74 imparts mechanical force to pitch drive gearbox 76. Pitch drive gearbox 76 is coupled to pitch drive pinion 78 such that pitch drive pinion 78 is rotated by pitch drive gearbox 76. Pitch bearing 72 is coupled to pitch drive pinion 78 such that the rotation of pitch drive pinion 78 causes rotation of pitch bearing 72. More specifically, in the exemplary embodiment, pitch drive pinion 78 is coupled to pitch bearing 72 such that rotation of pitch drive gearbox 76 rotates pitch bearing 72 and rotor blade 22 about pitch axis 34 to change the blade pitch of blade 22.

Pitch drive system 68 is coupled to control system 36 for adjusting the blade pitch of rotor blade 22 upon receipt of one or more signals from control system 36. In the exemplary embodiment, pitch drive motor 74 is any suitable motor driven by electrical power, pneumatic system and/or a hydraulic system that enables pitch assembly 66 to function as described herein. Alternatively, pitch assembly 66 may include any suitable structure, configuration, arrangement, and/or components such as, but not limited to, hydraulic cylinders, springs, and/or servo-mechanisms. Moreover, pitch assembly 66 may be driven by any suitable means such as, but not limited to, hydraulic fluid, and/or mechanical power, such as, but not limited to, induced spring forces and/or electromagnetic forces. In certain embodiments, pitch drive motor 74 is driven by energy extracted from a rotational inertia of hub 20 and/or a stored energy source (not shown) that supplies energy to components of wind turbine 10.

In the exemplary embodiment, pitch drive system 68 is positioned in a cavity 86 defined by an inner surface 88 of hub 20. In a particular embodiment, pitch drive system 68, is coupled, directly or indirectly, to inner surface 88. In an alternative embodiment, pitch drive system 68 is positioned with respect to an outer surface 90 of hub 20 and may be coupled, directly or indirectly, to outer surface 90.

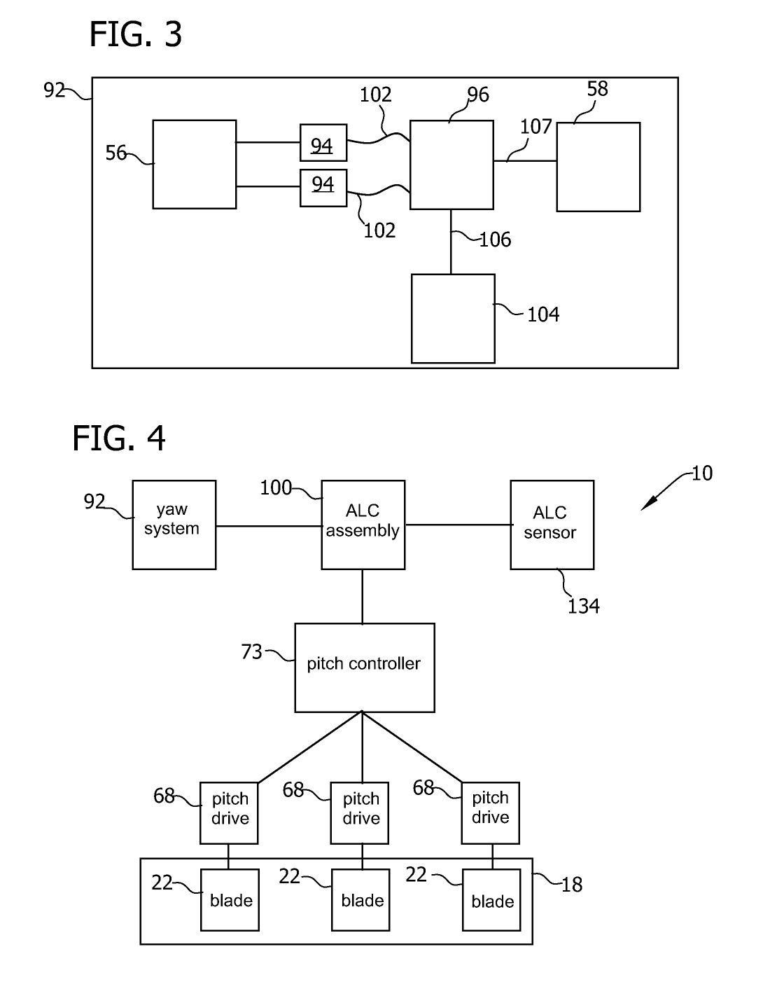

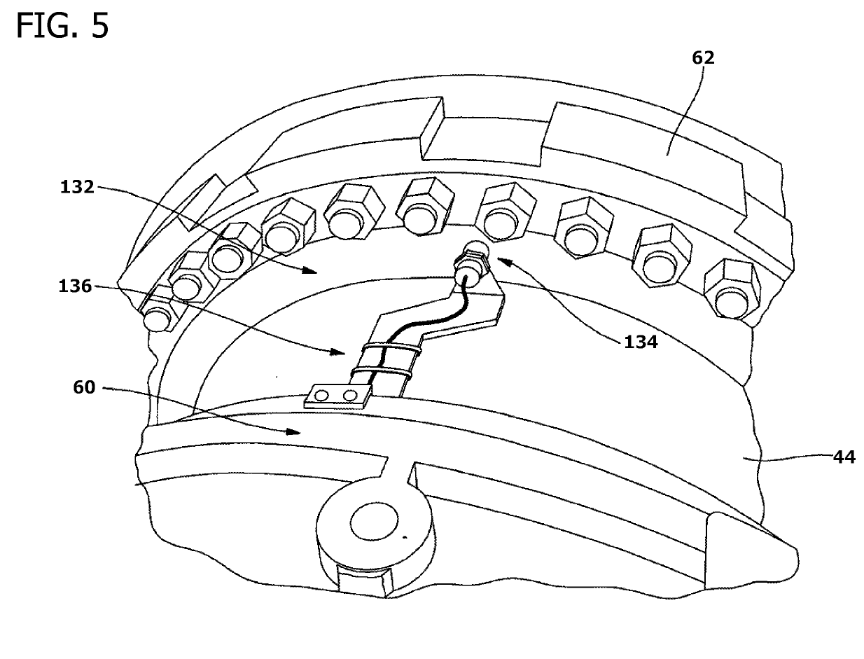

Nacelle 16 also includes a yaw drive mechanism 56 that may be used to rotate nacelle 16 and hub 20 on yaw axis 38 (shown in FIG. 1) to control the perspective of rotor blades 22 with respect to direction 28 of the wind. The perspective of rotor blades 22 with respect to direction 28 of the wind is also referred to as yaw angle. As shown schematically shown in FIG. 3, and further detailed below, yaw drive mechanism 56 forms part of a yaw system 92. Yaw drive mechanism 56 may be placed at the join between tower 12 and nacelle 16. Yaw drive mechanism 56 may collaborate with a bearing system for rotating nacelle 16. For example, in the exemplary embodiment, nacelle 16 also includes a main forward support bearing 60 and a main aft support bearing 62 arranged to interact with respective bearings mounted at tower 12 for enabling rotation of nacelle 16.

Forward support bearing 60 and aft support bearing 62 facilitate radial support and alignment of nacelle 16 and rotor shaft 44. Forward support bearing 60 is coupled to rotor shaft 44 near hub 20. Aft support bearing 62 is positioned on rotor shaft 44 near gearbox 46 and/or generator 42. Nacelle 16 may include any number of support bearings that enable wind turbine 10 to function as disclosed herein. Rotor shaft 44, generator 42, gearbox 46, high speed shaft 48, coupling 50, and any associated fastening, support, and/or securing device including, but not limited to, support 52 and/or support 54, and forward support bearing 60 and aft support bearing 62, are sometimes referred to as a drive train 64.

As schematically shown in FIG. 3, yaw system 92 includes at least one yaw motor 94 configured to adjust a yaw angle of wind turbine 10. In particular, yaw motor 94 may form part of, or be coupled to, yaw drive mechanism 56 for effecting rotation of nacelle 16 about yaw axis 38. Yaw system 92 may include more than one yaw motor. For example, the exemplary embodiment depicted in FIG. 3 includes two yaw motors 94. Yaw system 92 may include any suitable number of yaw motors that enable yaw system 92 to conveniently control yaw of wind turbine 10. For example, yaw system 92 may include between two and six yaw motors.

The at least one yaw motor 94 can generate a torque M for rotating nacelle 16, torque M being smaller than or equal to a maximum torque Mmax. Torque M of the at least one yaw motor may be positive or negative (i.e., torque M may be effected in counter clockwise or clockwise direction) depending on the direction of rotation required in order to align, or maintain aligned, rotor 18 to the desired yaw direction. For example, but not limited to, during operation of wind turbine 10, torque M may include torque values between 3000 and −3000 kNm or, more specifically, between 1500 and −1500 kNm.

Typically, yaw system 92 includes a yaw control assembly 96 for operating yaw motors 94. Yaw control assembly 96 may be operatively coupled to the at least one yaw motor 94 through cables 102. Yaw control assembly 96 typically forms part of control system 36. Alternatively, yaw control assembly 96 may be provided separated from control system 36.

As depicted in FIG. 3, yaw control assembly 96 is typically configured to receive a yaw reference signal based on a signal from one or more yaw sensor(s) 104 configured to sense at least one of position, velocity or acceleration of at least one reference point that is affected by the operation of the yaw system 92. In particular, yaw control assembly 96 may directly receive a signal from yaw sensor(s) 104 or may receive that signal after being processed by other elements of wind turbine 10. The reference point may be placed on the circumference of forward support bearing 60 and/or aft support bearing 62, adjacent to a yaw motor 94, or on another suitable location such as inside nacelle 16. Yaw sensor(s) 104 are typically communicatively coupled to yaw control assembly 96 through one or more cables 106, or other elements processing the signal generated by yaw sensor(s) 104, in order to provide yaw control assembly 96 with a yaw reference signal.

Alternatively, or in addition thereto, yaw control assembly 96 is further configured to receive a wind reference signal from sensor(s) provided in a meteorological mast 58. The wind reference signal typically includes strength and direction W of oncoming wind. More specifically, meteorological mast 58 (shown in FIG. 2) may include a wind vane and anemometer (neither shown in FIG. 2) for generating data included in the wind reference signal. A sensor in meteorological mast 58 is typically communicatively coupled to yaw control assembly 96 through one or more cables 107, or other elements processing the signal generated by the sensor, in order to provide yaw control assembly 96 with a yaw reference signal.

Typically, yaw control assembly 96 also receives input data from the at least one yaw motor 94 regarding the current motor torque M and/or other operating conditions of the at least one yaw motor 94, and gives instructions to the at least one yaw motor 94 as output data.

Yaw system 92 is typically configured to achieve optimal operation of wind turbine 10. This optimal operation may be achieved when nacelle 16 with rotor 18 are rotated towards a specific direction, herein referred to as the yaw set point. This specific direction may be determined using the wind direction or other factors that are deemed to be relevant. For example, a yaw setpoint may strive to achieve an orientation of the plane of rotor 18, i.e. the plane comprising rotor blades 22, perpendicular to wind direction 28. The yaw setpoint may also be a value corresponding not to a specific alignment but to other properties of the yaw system, such as for instance the yaw speed, the yaw acceleration or the yaw torque.

Typically, yaw system 100 is configured to use the reference signals set forth above for generating one or more control signals for operating the at least one yaw motor 94, so that yaw system 92 facilitates an optimal operation of wind turbine 10. Typically, the yaw control signal may correspond to a yaw motor set point or other control signal generated by yaw control assembly 96 for operation the at least one yaw motor 94. Further, yaw system 100 may generate output data based on one or more control parameters for effecting operation of the at least one yaw motor 94. The output data may include an instruction regarding magnitude of the desired motor torque M and/or the desired direction and speed of movement of nacelle 16 relative to tower 12 in accordance with the set point.

According to at least some embodiments herein, after yaw system 92 establishes a yaw setpoint, the actual yaw angle of rotor 18 is compared with the yaw setpoint and the difference is determined by yaw system 92 as the yaw error. The yaw system 92 applies a torque M through the at least one yaw motor 94 in order to minimize this yaw error and turn nacelle 16 and rotor 18 towards the yaw setpoint. The yaw setpoint can be monitored and re-calculated at any given time, in order to keep the setpoint up to date as the wind direction or wind strength changes. Thereby, yaw system 92 may continuously strive to minimize the yaw error and reach the yaw set point. In particular, motor torque M may be controlled by a yaw control assembly as described in the International Patent Application with publication number WO 2010/100271, which is incorporated herein by reference to the extent in which the application is not inconsistent with this disclosure and in particular those parts thereof describing a yaw system for a wind turbine.

According to embodiments herein, and as described above, the yaw system may be a soft yaw system. In particular, yaw control assembly 96 may be configured to continuously operate the at least one yaw motor during a period of time for maintaining the wind turbine at a yaw set point. In other words, yaw system 92 may be configured for: a) re-orienting nacelle 16 and rotor 18 towards a specific direction; and b) actively maintaining nacelle 16 and rotor 18 pointing to the specific directions. The latter function could be compared to an active braking of yaw rotation of wind turbine 10. According to at least some embodiments herein, a soft yaw system facilitates operation of an ALC system since the soft yaw system can continuously generate data related to: a) at least one property from the at least one yaw motor 94; and/or, b) one or more control signals for operating the at least one yaw motor 94. These data may be used by ALC assembly 100 for mitigating an asymmetric load acting on rotor 18, as further detailed below.

According to at least some embodiments herein, wind turbine 10 may further include a yaw brake system (not shown) for use in combination with, or alternatively, to yaw system 92. For example, such yaw brake system may be a hydraulic or electric brake configured to fix the position of nacelle 16 when required in order to avoid wear and high fatigue loads on wind turbine components. Yaw brake system may be configured to operate in case of failure of yaw system 92. The yaw brake system may be configured to operate in combination with yaw system 92 for maintaining nacelle 16 and rotor 18 pointing to a specific direction.

FIG. 4 is a block diagram of an exemplary scheme for controlling exemplary wind turbine 10. In the exemplary scheme, asymmetric load control (ALC) assembly 100 is configured to receive a yaw drive signal generated by yaw system 92. Further, ALC assembly 100 may be operatively connected to one or more ALC sensors 134 to receive signals corresponding to direct measurements of effects caused by an asymmetric rotor loading such as, but not limited to a bending or radial displacement of main shaft 44.

ALC assembly 100 is typically configured to process the yaw drive signal and, optionally, the signal from ALC sensor(s) 134. For example, ALC assembly 100 may analyze the yaw drive signal and/or the signal from ALC sensor(s) 134 to determine an asymmetric load acting on rotor 18 and generates information for mitigating the asymmetric load. Alternatively or in addition thereto, ALC assembly 100 may use one of these signals for validating a reference signal used for ALC or as a redundant data. Further, ALC assembly 100 is typically configured to generate an ALC signal based on the received signal(s) for mitigating an asymmetric loading.

According to the exemplary embodiment, and other embodiments herein, ALC assembly 100 is operatively connected to a pitch controller 73. Pitch controller 73 receives the ALC signal and, based on this signal, operates at least one of pitch drive systems 68 for mitigating an asymmetric loading acting on rotor 18.

According to at least some embodiments herein, ALC assembly 100 is configured to mitigate an asymmetric load directly based on a yaw drive signal. That is, ALC assembly 100 may be configured for determining an ALC signal facilitating mitigation of an asymmetric rotor loading directly based on the reference data contained in the yaw drive signal. Thereby, ALC may be implemented using information generated by yaw system 92. The yaw drive signal is typically suitable for directly implementing ALC since a yaw drive signal according to embodiments herein typically provides information, which can be correlated to displacement of wind turbine components (e.g., main shaft 44) caused by an asymmetric load of wind turbine 10.

Exemplarily, ALC assembly 100 may be further configured to obtain an estimation of at least one wind turbine property associated to a bending of rotor shaft caused by an asymmetric rotor loading, such as a deflection of a main shaft flange of the wind turbine or a displacement of a gearbox of the wind turbine from one or more predetermined positions. For example, but not limited to, an ALC function implemented in ALC assembly 100 may estimate a yaw moment, which might be equivalent to the measurement of a yaw torque reported by ALC sensors. This estimation may be obtained based on, at least, the yaw drive signal. In such embodiments, ALC assembly 100 may be further configured to mitigate an asymmetric rotor loading directly based on the estimation.

According to embodiments herein, the yaw drive signal corresponds to at least one property from the at least one yaw motor 94. For example, the at least one property may be dependent on a motor workload of the at least one yaw motor 94. In particular, the at least one property from the at least one yaw motor 94 may be a yaw motor torque and the yaw drive signal may then correspond to the yaw motor torque.

Exemplarily, the motor torque M applied by a soft yaw system for keeping wind turbine 10 in a desired yaw angle may be recorded and transmitted to ALC assembly 100 for implementing ALC or validating measurements from ALC sensors. Typically, the magnitude of this motor torque M will be dependent on asymmetric loads acting on the rotor that cause a yaw wise rotational force to be applied to wind turbine 10 itself.

According to at least some embodiments herein, the yaw drive signal may correspond to a control signal for operating the at least one yaw motor such as, but not limited to, a yaw motor setpoint, a yaw error, or from any other data generated by the yaw system 92 for controlling the at least one yaw motor 94. Further, the yaw drive signal may correspond to a plurality of properties. For example, the yaw drive signal may include data corresponding to a yaw motor setpoint and to yaw motor torque M.

A yaw drive signal according to embodiments herein may be generated in a number of different ways. For example, the current that is applied to the yaw motor may be measured. The control system of wind turbine 10 may estimate the yaw motor torque M based on the measured current and, optionally, on other parameters of yaw system 92. The estimation of the yaw motor torque M may then be used for ALC. Alternatively or in addition thereto, the power of the at least one yaw motor 94 and/or a rotational speed thereof may be measured and used for generating the yaw drive signal. Any other property of yaw motor 94 or control signal for operation thereof may be used for generating a yaw drive signal such as, but not limited to, voltage or frequency applied to the at least one yaw motor 94.

ALC assembly 100 may process a yaw drive signal for conveniently implement control of asymmetric loads. Alternatively or in addition thereto, yaw system 92 may generate a yaw drive signal based on already processed data, so that the yaw drive signal may be used directly by ALC assembly 100. The yaw drive signal may be generated in analog and/or digital format.

A yaw system typically provides a yaw drive signal having a high quality. Thereby, reliability of ALC may be further improved by using the yaw drive signal for mitigating an asymmetric rotor loading. Furthermore, an ALC assembly 100 mitigating an asymmetric load directly based on the yaw drive signal may render unnecessary implementation of sensors for ALC thereby reducing costs. It should be further noted that ALC sensors may degrade with time or may be prone to failure. Typically, a yaw system is less prone to such degradation or failure, so that it provides a reliable signal for implementing and/or validating ALC.

According to at least some embodiments herein ALC yaw system 100 may generate the yaw drive signal in a continuous manner during operation of wind turbine 10. In particular, ALC yaw system 100 may be a soft yaw system configured to: a) generate a yaw drive signal during yaw re-alignment of wind turbine 10, and, b) generate a yaw drive signal during time periods in which yaw is semi-stationary, so that the yaw system strives to maintain wind turbine 10 at a specific yaw angle.

According to embodiments herein, a continuous generation of the yaw drive signal includes a discrete yaw drive signal generated during sufficiently short time intervals. For example, a soft yaw system may provide a yaw drive signal at time periods between 1 and 1000 milliseconds, such as 20 milliseconds. A soft yaw system may provide a particularly reliable signal for facilitating operation of ALC assembly 100.

Optionally and as set forth above, at least some embodiments herein contemplate implementation of ALC sensors. In such embodiments, ALC assembly 100 may be configured to mitigate an asymmetric load using an asymmetric load signal generated by the ALC sensors and a yaw drive signal. Thereby, reliability of ALC may be increased. In some embodiments herein, ALC assembly 100 is configured to: a) perform ALC based on the signal provided by ALC sensors; and b) use the yaw drive signal for evaluating and/or validating performance of the ALC sensors. According to other embodiments, ALC assembly 100 is configured to use the yaw drive signal only as a redundant signal for ALC in case that the ALC sensors fail. Further, ALC assembly 100 may be configured to mitigate asymmetric load by generating an ALC control signal based on the combination of the signal from ALC sensors and the yaw drive signal.

An ALC sensor is typically able to detect an asymmetric load acting on rotor 18 and translating into moments acting on hub 20 and, subsequently, to rotor shaft 44. These moments may be manifested as a bending of a shaft of wind turbine 10, a deflection of a main shaft flange of the wind turbine, a displacement of a gearbox of the wind turbine from one or more predetermined positions as deflections, and/or strains at a main shaft flange 132 caused by an asymmetric rotor loading. More specifically, wind turbine 10 may include an ALC sensor system configured to: a) directly measure displacements or moments resulting from an asymmetric rotor loading; and b) generate an asymmetric load signal based on the direct measurement. For example, wind turbine 10 may include one or more ALC sensors 134 configured to: a) directly measure a deflection and/or displacement of an element of wind turbine 10 from a predetermined position, and b) generate an asymmetric load signal corresponding to the direct measurement. Typically, ALC sensor(s) 134 is a proximity sensor including a sensor bracket 136 configured to enable measurement of a bending or radial displacement of rotor shaft 44.

In the exemplary embodiment, and other embodiments herein, wind turbine 10 includes ALC sensor 134 configured to directly measure effects of asymmetric rotor loading, such as a bending of a shaft of wind turbine 10 caused by an asymmetric rotor loading, a deflection of a main shaft flange of the wind turbine, or a displacement of a gearbox of the wind turbine from one or more predetermined positions. In particular, ALC sensor 134 may be a proximity sensor that measure displacement or strain of the shaft using sensor technologies based on acoustic, optical, magnetic, capacitive or inductive field effects.

An ALC sensor according to embodiments herein may be configured to sense asymmetric rotor loading acting on other elements of wind turbine 10, such as gearbox 46. In the exemplary embodiment, only one set of sensors 134 is illustrated. According to at least some embodiments, wind turbine 10 includes at least three set of sensors 134 to measure displacements of main shaft flange 132 or displacement of gearbox 46 caused by an asymmetric load. ALC sensor(s) 134 may be configured as described in the US Patent Applications with publication numbers US2004/0151575 and US 2006/0002792 which are incorporated herein by reference to the extent in which the application is not inconsistent with this disclosure and in particular those parts thereof describing sensors for measuring effects of asymmetric rotor loading.

As set forth above, ALC assembly 100 may be configured to mitigate an asymmetric rotor loading by pitching at least one of rotor blades 22. In particular, the yaw drive signal and/or the asymmetric load signal may be used to determine a pitch for each of rotor blades 22. For example, the yaw drive signal may be used to estimate a shaft displacement and, thereby, the magnitude and/or phase angle of asymmetric rotor loading. The estimated magnitude and/or phase angle can then be used to determine a blade pitch command for at least one of rotor blades 22 to reduce the asymmetric rotor loading. A coordinate transformation (e.g., a Parks DQ transformation), a bias estimation method and/or other control scheme may be implemented into control system 36 and used to calculate a pitch angle for each rotor blade to reduce the overall asymmetric rotor loading.

As another example; sensor readings from ALC sensor 134 indicating measured displacement or moments may be used by ALC assembly 100 to determine a pitch command for each rotor blade 22 to reduce or counter an asymmetric rotor loading. In this control scheme, a yaw drive signal may be used for validating the reading from ALC sensor 134. In particular, the yaw drive signal may be used for providing an estimation of a presumably correct measurement from ALC sensor 134. Thereby, the estimation may then be compared with actual readings from ALC sensor 134 in order to detect any abnormalities occurring in ALC sensor 134.

According to at least some embodiments, the pitch command is determined by using information from both the asymmetric load signal from ALC sensor 134 and the yaw drive signal generated by yaw system 92. ALC may also include determining a favorable yaw orientation to reduce pitch activity during mitigation of asymmetric rotor loading, as described in the US Patent Application with publication number US 2006/0002792 A1.

Control system 36 may implement yaw control, ALC, pitch control, and management of ALC sensors. Control system 36 may also implement a balance control of wind turbine 10 for decreasing an unbalance of rotor 18. Such balance control may also use a yaw drive signal generated by yaw system 92 as described in the International Patent Application with publication number WO 2010/133512, which is incorporated herein by reference to the extent in which the application is not inconsistent with this disclosure and in particular those parts thereof describing a method and a system for balancing a wind turbine.

In the exemplary embodiment, control system 36 is shown as being centralized within nacelle 16, however, control system 36 may be a distributed system throughout wind turbine 10, on support system 14, within a wind farm, and/or at a remote control center. Control system 36 typically includes a processor 40 configured to perform the methods and/or steps described herein. Further, many of the other components described herein include a processor. As used herein, the term “processor” is not limited to integrated circuits referred to in the art as a computer, but broadly refers to a controller, a microcontroller, a microcomputer, a programmable logic controller (PLC), a field programmable gate array (FPGA), an application specific integrated circuit, and other programmable circuits, and these terms are used interchangeably herein. It should be understood that a processor and/or a control system can also include memory, input channels, and/or output channels. Control system 36 typically includes means for communication between the different systems such as electrical connections and/or wireless communication devices.

In the embodiments described herein, memory may include, without limitation, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, input channels include, without limitation, sensors and/or computer peripherals associated with an operator interface, such as a mouse and a keyboard. Further, in the exemplary embodiment, output channels may include, without limitation, a control device, an operator interface monitor and/or a display.

Processors described herein process information transmitted from a plurality of electrical and electronic devices that may include, without limitation, sensors, actuators, compressors, control systems, and/or monitoring devices. Such processors may be physically located in, for example, a control system, a sensor, a monitoring device, a desktop computer, a laptop computer, a programmable logic controller (PLC) cabinet, and/or a distributed control system (DCS) cabinet. RAM and storage devices store and transfer information and instructions to be executed by the processor(s). RAM and storage devices can also be used to store and provide temporary variables, static (i.e., non-changing) information and instructions, or other intermediate information to the processors during execution of instructions by the processor(s). Instructions that are executed may include, without limitation, wind turbine control system control commands. The execution of sequences of instructions is not limited to any specific combination of hardware circuitry and software instructions.

In the exemplary embodiment, control system 36 includes a real-time controller that includes any suitable processor-based or microprocessor-based system, such as a computer system, that includes microcontrollers, reduced instruction set circuits (RISC), application-specific integrated circuits (ASICs), logic circuits, and/or any other circuit or processor that is capable of executing the functions described herein. In one embodiment, the controller may be a microprocessor that includes read-only memory (ROM) and/or random access memory (RAM), such as, for example, a 32 bit microcomputer with 2 Mbit ROM, and 64 Kbit RAM. As used herein, the term “real-time” refers to outcomes occurring a substantially short period of time after a change in the inputs affect the outcome, with the time period being a design parameter that may be selected based on the importance of the outcome and/or the capability of the system processing the inputs to generate the outcome.

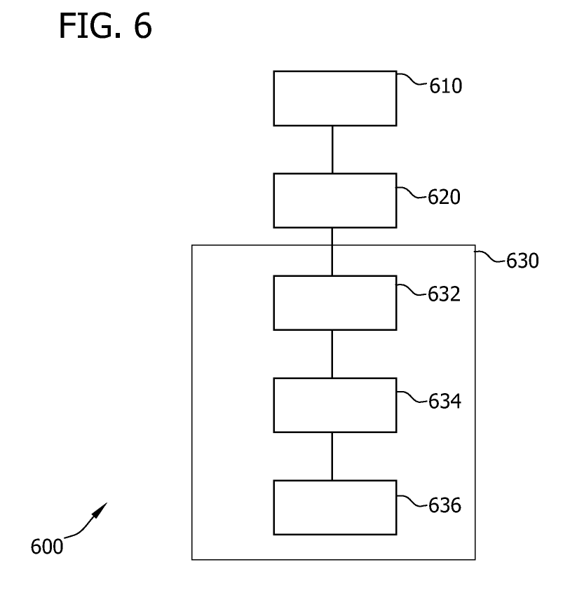

FIG. 6 is a flow chart illustrating an exemplary method 600 of operating wind turbine 10. Method 600 may include generating 610 a signal appropriate for being used for ALC of wind turbine 10. According to embodiments herein, the generated signal includes, at least, a yaw drive signal generated by yaw system 92, as described above. According to at least some embodiments herein, the signal further includes an asymmetric load signal generated by ALC sensor 134.

Method 600 may further include receiving 620 the signal(s) generated for ALC. Typically, these signals are received by ALC assembly 100. Typically, the components of ALC assembly 100 receiving the signals (e.g., a processor or an analog to digital converter) are coupled to the elements of wind turbine 10 used for detecting an asymmetric load (e.g., yaw system 92 and/or ALC sensor 134). ALC assembly 100 may convert these signals to a usable format, if required.

Method 600 further includes mitigating 630 an asymmetric load acting on rotor 18 using the signals for ALC, namely using a yaw drive signal and, optionally, an asymmetric load signal generated by ALC sensor(s) 134. Mitigating 630 may further include a step 632 for determining the effects (e.g., loads) caused on one or more components of wind turbine 10 by an asymmetric load of rotor 18 using the signals for ALC. The control system of wind turbine 10 may use any suitable mathematical equation or previously acquired semi-empirical data to convert the input data (e.g., motor torque, current, yaw setpoint, etc) to relevant asymmetric load data (e.g., a shaft bending, a deflection of main shaft flange 132, and/or a displacement of gearbox 46). Step 632 may also include determining the load on rotor blades 22 as well as any properties of an asymmetric rotor loading.

Mitigating 630 may further include a step 634 for determining a response to reduce or counter asymmetric rotor loading. For example, in response to a particular asymmetric rotor loading, the control system of wind turbine 10 may determine that the response should be to change the pitch of one or more blades 22. As another example, the determined response may be applying a brake to stop or slow rotation of hub 20. As a further example, the determined response may be to exert some action such as inducing a compensatory yaw adjustment.

Mitigating 630 may further include a step 636 for generating a signal that enables responding to an asymmetric load. For example, a response signal may be generated in the form of, for example, a data packet or a set of control signals transmitted over individual control lines, to cause pitch controller 73 to change the pitch of one or more of blades 22. If the selected response fails to cause the wind turbine to operate within an acceptable operating range, method 600 can be repeated as often as necessary or even discontinued, resulting in a pitch control without the benefits of the described ALC algorithm(s).

Exemplary embodiments of systems and methods for operating a wind turbine are described above in detail. The systems and methods are not limited to the specific embodiments described herein, but rather, components of the systems and/or steps of the methods may be utilized independently and separately from other components and/or steps described herein. For example, ALC according to embodiments herein may be implemented by a remote controller communicatively coupled to wind turbine 10. The embodiments described herein are not limited to practice with only the wind turbine systems as described herein. Rather, the exemplary embodiment can be implemented and utilized in connection with many other rotor blade applications.

Although specific features of various embodiments of the invention may be shown in some drawings and not in others, this is for convenience only. In accordance with the principles of the present disclosure, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. While various specific embodiments have been disclosed in the foregoing, those skilled in the art will recognize that the spirit and scope of the claims allows for equally effective modifications. Especially, mutually non-exclusive features of the embodiments described above may be combined with each other. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A wind turbine, comprising:
a) a rotor and at least one rotor blade coupled to said rotor;
b) a yaw system including at least one yaw motor for adjusting a yaw angle of the wind turbine, the yaw system being configured for generating a yaw drive signal corresponding to at least one of:
i) a property from the at least one yaw motor; or,
ii) a control signal for operating the at least one yaw motor; and,
c) an asymmetric load control assembly configured to receive the yaw drive signal,
wherein said asymmetric load control assembly is further configured to mitigate an asymmetric load acting on the rotor using said yaw drive signal.

2. The wind turbine according to claim 1, wherein said yaw system is a soft yaw system.

3. The wind turbine according to claim 2, wherein said property from the at least one yaw motor is a yaw motor torque and the yaw drive signal corresponds to the yaw motor torque.

4. The wind turbine according to claim 3, wherein said yaw drive signal corresponds to a current applied to the at least one yaw motor.

5. The wind turbine according to claim 1, wherein said asymmetric load control assembly is further configured to mitigate said asymmetric load acting on the rotor by pitching said at least one rotor blade.

6. The wind turbine according to claim 1, wherein said asymmetric load control assembly is configured to mitigate said asymmetric load directly based on said yaw drive signal.

7. The wind turbine according to claim 6, wherein said asymmetric load control assembly is further configured to:
obtain an estimation of at least one wind turbine property associated to a bending of a shall of the wind turbine, said estimation being obtained based on said yaw drive signal; and,
mitigate an asymmetric load acting on the rotor based on said estimation.

8. The wind turbine according to claim 1, further comprising one or more sensors configured to:
i) directly measure at least one wind turbine property associated to a bending of rotor shaft; and,
ii) generate an asymmetric load signal corresponding to the direct measurement,
wherein said asymmetric load control assembly is configured to mitigate said asymmetric load using said asymmetric load signal and said yaw drive signal.

9. The wind turbine according to claim 8, wherein said asymmetric load control assembly is further configured to:
i) mitigate said asymmetric load directly based on said asymmetric load signal; and,
ii) use said yaw drive signal for validating said asymmetric load signal.

10. A method of operating a wind turbine, the wind turbine including a rotor, at least one rotor blade coupled to said rotor, and a yaw system including at least one yaw motor for adjusting a yaw angle of the wind turbine, said method comprising:
a) generating a yaw drive signal corresponding to at least one of:
i) a property from the at least one yaw motor; or,
ii) a control signal for operating the at least one yaw motor; and
b) mitigating an asymmetric load acting on the rotor using said yaw drive signal.

11. The method according to claim 10, further comprising continuously operating the at least one yaw motor during a period of time for maintaining the wind turbine at a yaw set point.

12. The method according to claim 11, wherein said property from the at least one yaw motor is a yaw motor torque and the yaw drive signal corresponds to the yaw motor torque.

13. The method according to claim 12, wherein said yaw drive signal is a current applied to the at least one yaw motor.

14. The method according to claim 10, wherein mitigating said asymmetric load includes pitching said at least one rotor blade.

15. The method according to claim 10, wherein mitigating said asymmetric load is performed directly based on said yaw drive signal.

16. A control system for a wind turbine including at least one yaw motor for adjusting a yaw angle of the wind turbine, said control system comprising an asymmetric load control assembly configured to:
a) receive a yaw drive signal; and,
b) mitigate an asymmetric load acting on the rotor using said yaw drive signal.

17. The control system according to claim 16, wherein the yaw drive signal corresponds to at least one of:
i) a property from the at least one yaw motor; or,
ii) a control signal for operating the at least one yaw motor.

18. The control system according to claim 17, wherein said property from the at least one yaw motor is a yaw motor torque of the at least one yaw motor.

19. The control assembly according to claim 18, wherein said yaw drive signal is a current applied to the at least one yaw motor.

20. The control assembly according to claim 16, wherein mitigating said asymmetric load includes pitching said at least one rotor blade.
